(19) United States
(12) Patent Application Publication
(10) Pub. No.: US 2005/0062289 A1
(43) Pub. Date: Mar. 24, 2005

(54) Heat/electric power supply system having power storage unit

(76) Inventors: Tong-Rae Cho, Daejon City (KR); Soichi Sato, Nara (JP)

Correspondence Address: JORDAN AND HAMBURG LLP, 122 EAST 42ND STREET, SUITE 4000, NEW YORK, NY, 10168, US

(21) Appl. No.: 10/221,511

(22) PCT Filed: Mar. 14, 2001
(86) PCT No.: PCT/JP01/02029

(30) Foreign Application Priority Data
Mar. 17, 2000 (JP) 2000-121811

(51) Int. Cl. H02J 7/00; H02J 9/00

(52) U.S. Cl. 290/2; 307/67

(57) ABSTRACT

A heat/electric supply system the entire efficiency of which is enhanced while reducing the capacity of facility. The heat/electric supply system is characterized in that electric power is supplied from a generator, a commercial power supply and a power storage unit in the time zone when power consumption by the power load is higher than a specified output C1 and commercial power is stored in a power storage unit in the night time zone can be utilized at the time of peak power demand, the backup power at the time of peak power demand can be reduced.

### FIELD OF THE INVENTION

The present invention relates to a heat/electric power supply system (it is also called a cogeneration system.) which supplies heat and electric power.

### BACKGROUND ART

A heat/electric power supply system attracts attention recently as a system which uses effectively waste heat generated on the occasion of power generation.

Since heat is also effectively used by waste-heat recovery with electric power from a generator in a heat/electric power supply system, the use efficiency of energy is high.

In recent years, introduction of an electric power supply system of an independent form is considered.

This is because it was admitted with deregulation of Electric Utility Law that entrepreneurs other than a general electric industry company entered into the electric industry.

A specific point supply where the area to which supplies electricity is limited is mentioned as an entry form to such the electric industry.

In such a case, the supply contractor who supplies electricity can receive no electric supply from a general electric industry company (an electric industry company is also said.), except for the time of backup, such as an accident or a scheduled inspection.

Moreover, since a heat/electric power supply system used conventionally is working a generator according to the electric power load, it has prepared the mass generator corresponding to maximum power consumption.

And when there is little power consumption, a generator is operated by little load.

When operated with a specific output, the heat engine which drives a generator, for example, the gas turbine using fuel gas is the most efficient, and efficiency falls in low load operation.

Furthermore, by the extreme low load, operation is impossible.

Therefore, when the electric power load exceeds a fixed quantity, there is a commercial electric power backup-type heat/electric power supply system to which bought commercial electric power is also supplied collectively in spite of an electric industry company's resistance.

Moreover, there is a commercial electric power backup-type heat/electric power supply system to which bought commercial electric power is supplied after a generator is stopped at midnight when the electric power load is extremely low.

In such a case, it cannot apply to specific point supply and when the electric power load exceeds a fixed quantity, because of being collectively supplied by bought commercial electric power, an electric industry company's resistance is strong.

Then, the self-conclusion type heat/electric power supply system which of the form does not receive electric power from a commercial power supply, and is operated except for the special cases, such as failure, is proposed.

That is, the self-conclusion type heat/electric power supply system which stores electric power in a power storage unit, operating a generator, even when there is little power consumption, and is proposed.

The self-conclusion type heat/electric power supply system which supplies electric power by electric power from a generator and electric power from a power storage unit, when there is much power consumption, is also proposed (JP, 11-155244, A).

Power consumption is changed according to the season of spring, summer, fall and winter (seasonal variation), and is changed in daytime and nighttime for one whole day (day-night change).

In the case of a back-up type heat/electric power supply system, in a peak time zone of electric power consumption, there is a necessity of providing commercial electric power and electric power from a generator.

Therefore, you have to make power generation capability (design capability) of a generator in agreement with (maximum power consumption—commercial electric power).

Moreover, also in a self-conclusion type heat/electric power supply system, there is a necessity of providing electric power from a generator and electric power stored in a power storage unit in a peak time zone.

Therefore, you have to make power generation capability (design capability) of a generator in agreement with (maximum power consumption-electric power stored in a power storage unit).

Both the back-up type heat/electric power supply system and the self-conclusion type heat/electric power supply system are considerably miniaturized as compared with a usual heat/electric power supply system.

However, for the wider range spread of heat/electric power supply systems, the heat/electric power supply system needed to be made still smaller, and the further cost cut of a heat/electric power supply system needed to be aimed at.

And, for the wider range spread of heat/electric power supply systems, you have to aim the heat/electric power supply system which has a merit also for the electric industry company that further equalization of the commercial electric power load can be attained, using commercial electric power in the time zone (for example, evening charge time zone) when consumption falls, while aiming at reduction of backup commercial electric power, even when receiving backup of commercial electric power in the time zone of peak power consumption.

### OBJECT OF THE PRESENT INVENTION

The subject of the present invention is offering the heat/electric power supply system which can attain further miniaturization rather than a back-up type heat/electric power supply system and a self-conclusion type heat/electric power supply system.

Further, the subject of the present invention for the wider range spread of heat/electric power supply systems is to offer a heat/electric power supply system with a merit also for an electric industry company that further equalization of the commercial electric power load can be attained, while aiming at reduction of backup commercial electric power, even when receiving backup of commercial electric power in a peak time zone of electric power consumption, using commercial electric power in the time zone (For example, evening charge time zone) when power consumption falls.

### DISCLOSURE OF THE INVENTION

The inventor canceled the fault of the conventional technology, and as a result of studying many things so that the-present-invention subject should be attained, we came to complete the present invention.

Although the so-called conventional back-up type heat/electric power supply system needed to receive supply of commercial electric power in a peak time zone of electric power consumption of a heat/electric power supply system for wider range spread, there was an electric industry company's resistance to do that.

That is, as for a back-up type heat/electric power supply system, although an electric industry company also had a merit that some commercial electric power was used in the evening charge time zone, it was inadequate absolutely for the wider range spread of heat/electric power supply systems. Furthermore, the subject that further miniaturization was attained by keeping electric power in a peak time zone of the generator of a heat/electric power supply system low was left behind.

Moreover, the backup-type heat/electric power supply system was a system which receives backup of commercial electric power in a peak time zone of electric power consumption, and it was still far to consider as a heat/electric power supply system with a merit for the electric industry company that an equalization of the commercial electric power load can be attained.

Then, in order to solve the above faults and subjects of a back-up type heat/electric power supply system, the self-conclusion type heat/electric power supply system which does not need backup of commercial electric power has been proposed.

However, the feature of this self-conclusion type heat/electric power supply system is attaining miniaturization of a heat/electric power supply system by supplying electric power from a generator and electric power stored in a power storage unit together in a peak time zone, and storing electric power in a power storage unit by operating a generator positively in the time zone with little power consumption (for example, the time zone at night).

However, although it needed to reply to the request of further miniaturization for the wider range spread of heat/electric power supply systems, it was not able to reply to this enough.

Moreover, since the output of a generator is equalized by operating a generator also in a night time zone, and storing electric power in a power storage unit, operation efficiency of a heat/electric power supply system is good.

However, since consumption of commercial electric power in the evening charge time zone was not able to be expected and equalization of the load of commercial electric power was not able to be attained, it was also the system which does not have such a merit for the electric industry company.

Based on such a situation, the inventor keenly realized that whether the wider range spread of heat/electric power supply systems can be aimed at was replying to the request of further miniaturization of a heat/electric power supply system thoroughly.

And daring introduce the way of thinking of an inversion to the self-conclusion type heat/electric power supply system and utilizing commercial electric power as positively as possible, the inventor will have noticed that further miniaturization of a self-conclusion type heat/electric power supply system (a system characterized by not using commercial electric power at all) can be attained.

Moreover, the inventor did his best to achieve a subject of realizing the system which also has a merit for an electric industry company that equalization of the load of commercial electric power can be attained to use commercial electric power as positively as possible in the time zone of evening charge, in the return to receive backup of commercial electric power in a peak time zone.

That is, the present invention is based on the fundamental concept of providing backup electric power of commercial electric power in a peak time zone with commercial electric power conserved in few consumption time zone (for example, evening charge time zone).

The view similar to the ice thermal storage using an evening charge or the view of the pumped hydro power generation which stores commercial electric power at night was applied to the present invention.

Then, while using the composition of a self-conclusion type heat/electric power supply system as it was just as it is, the present invention which is the heat/electric power supply system having a power storage unit was able to be completed by adding the composition which utilizes commercial electric power as positively as possible.

That is, the commercial-electric-power use form of the present invention is storing commercial electric power positively (in a power storage unit which the heat/electric power supply system had) in the evening charge time zone, and supplying commercial electric power (stored in a storage battery) in a peak time zone.

Amount of backup of commercial electric power required in a peak time zone becomed less, and it enabled to attain further equalization of the load of commercial electric power rather than the mere conventional back-up type heat/electric power supply system.

In this way, a system with the very bigger merit also for an electric industry company than the conventional back-up type heat/electric power supply system can be proposed.

On the other hand, since miniaturization was pursued ultimately, it became being able to attain the cost cut of equipment, and a saving of space (equipment installation performance).

A possibility of the wider range spread of heat/electric power supply systems increased.

And it became possible to store commercial electric power in the evening charge time zone in a power storage unit of each diffused heat/electric power supply system.

Thereby, it is expectable that a power storage unit can have the effect of leading to the cut of the whole commercial electric power in a peak time zone also as the whole state, by achieving the same function as the reservoir of the pumped hydro power generation, and using commercial electric power stored in the night time zone in a peak time zone.

Whether a heat/electric power supply system contributes to a national energy-saving policy depends on how this system spreads broadly.

For that purpose, it is especially important to store commercial electric power in a power storage unit of a heat/electric power supply system in the time zone (evening charge time zone) when consumption of commercial electric power falls, in the return to receive backup of commercial electric power for the peak hour of power consumption.

It is important especially for wider range spread to consider as a system with a merit also for an electric industry company that the demand of commercial electric power arises in the time zone (evening charge time zone) when consumption of commercial electric power falls.

Although an inventor used to complete the present invention through such circumstances, the present invention as defined in each claim below is indicated.

In addition, although the present invention is a system invention, a method invention is also written substantially. As for a method invention, a system defined in claim 1˜13 shall read as a method.

Claim 1 A heat/electric supply system having a storage power unit characterized in that electric power is supplied from a generator, a commercial power supply and a power storage unit in a time zone when power consumption by the power load is higher than a specified output C1.

Claim 2 A heat/electric supply system having a storage power unit as defined in claim 1, wherein commercial electric power is stored in a power storage unit in a time zone when power consumption by the power load is not more than a specific output C2.

Claim 3 A heat/electric supply system having a storage power unit as defined in claim 1˜2, wherein commercial electric power is stored in a power storage unit and is supplied to the power load in a time zone when power consumption by the power load is not more than a specific output C2.

Claim 4 A heat/electric supply system having a storage power unit as defined in claim 1˜3, wherein commercial electric power is stored in a power storage unit or is supplied to the power load in a time zone when power consumption by the power load is not more than a specific output C2.

Claim 5 A heat/electric supply system having a storage power unit as defined in claim 1˜4, wherein a component of heat/electric supply system is a gas turbine, an engine, or a fuel cell.

Claim 6 A heat/electric supply system having a storage power unit as defined in claim 1˜5, wherein a generator is an alternative current generator or a direct current generator.

Claim 7 A heat/electric supply system having a storage power unit as defined in claim 1˜6, wherein hydrogen and oxygen are manufactured by electrolyzing water and stored in a time zone when power consumption by the power load is not more than a specific output C1.

Claim 8 A heat/electric supply system having a storage power unit as defined in claim 1˜7, wherein a power storage unit comprises one sort or two sorts or more chosen among a lithium secondary battery, a nickel hydride battery, and a capacitor.

Claim 9 A heat/electric supply system having a storage power unit as defined in claim 1˜8, wherein the heat collected from the heat recovery unit is supplied to one sort or two sorts or more chosen among an absorption type freezer and a warm water boiler.

Claim 10 A heat/electric supply system having a storage power unit as defined in claim 1˜9, wherein a time zone contains a time zone at night or a time zone when power consumption by the power load is not more than specific value C2 is only a time zone at night.

Claim 11 A heat/electric supply system having a storage power unit as defined in claim 1˜10, wherein a time zone when power consumption by the power load is higher than a specified output C1 is read as a time zone of peak power consumption of the electric power load.

Claim 12 A heat/electric supply system having a storage power unit as defined in claim 1˜11, wherein a time zone when power consumption of the electric power load falls is read as a time zone when power consumption by the power load is not more than a specific output C2.

Claim 13 A heat/electric supply system having a storage power unit as defined in claim 1˜12, wherein a time zone when power consumption by the power load is not more than a specific output C2 is read as the night time.

### EXPLANATION OF A TERM

The term used for this specification is explained below.

(1) The electric power load, power consumption, power consumption of the electric power load

Power consumption of the electric power load and the electric power load means the electric power load of the heat/electric power supply system of the present invention, power consumption of a heat/electric power supply system, and power consumption of the electric power load of a heat/electric power supply system, unless it refuses especially.

In pointing out the case of commercial electric power, we shall specify specially.

(2) A specific output

The specific outputs C1, C2 used here are the set-up electric-power value not more than C0.

They also have the case of a fixed value which is not related to time and not changing with time.

They may be set up so that they may change with time (a month, a day, a season, etc. are included.) (namely, when C1 and C2 are the functions of time t).

C0 is the peak power value of a heat/electric power supply system for one whole day here. C0≧C1, C2 here.

The time zone when power consumption of the electric power loads is more than a specific output C1 contains a peak time zone (for example, a peak time zone of electric power consumption of the morning, the evening or the daytime).

Generally a peak time zone of power consumption of the electric power load of a heat/electric power supply system and a peak time zone of power consumption of commercial electric power tend to be in agreement.

A peak time zone says 10:00 a.m.˜4:00 p.m., 0:00 p.m.˜4:00 p.m., 1:00 p.m.˜3:00 p.m., etc.

The time zone when power consumption of the electric power load is not more than the specific output C2 contains the time zone (for example, evening charge time zone) where power consumption of the electric power load (there are a case of the electric power load of a heat/electric power supply system and a case of the electric power load of commercial electric power in the electric power load said here.) falls.

Generally the time zone when power consumption of the electric power load of a heat/electric power supply system falls, and the time zone when power consumption of commercial electric power falls tend to be in agreement.

In addition, when only expressing it as an “evening charge time zone” and a “night time zone” , the meaning of “the time zone with little electric power load (the electric power load falls)” is included. time zone is 0:00 a.m.˜6:00 a.m. etc. here at night, or it is the evening charge time zone.

(3) Heat/electric power supply system

A heat/electric power supply system is a system which collects waste heat produced by generator operation, and supplies heat while supplying electric power from a generator, and is a distributed system which needs to install in an electric-power consumer place.

Spreading especially this system broadly by attaining miniaturization low-cost-ization is called for.

An output comprises hundreds˜500 kW class of a thing, or the heat/electric power supply system of the present invention comprises a high polymer electrolyte type fuel cell (home use) of 2 kW or less of outputs, and has a power storage unit of 10 kW or fewer etc.

(4) Generator

A generator defined here is a generator used in a heat/electric power supply system, and the generator which collected waste heat while generating electricity is said.

The equipment which supplies electric power, wherein the driving force generated by operation of heat engine, such as a gas turbine or an internal-combustion engine, is changed into electricity with a dynamo is included.

Or like a fuel cell, the equipment which changes fuel such as hydrocarbon and hydrogen into electricity directly and electrochemically, and supplies electric power is included.

A heat/electric power supply system (it is based on a gas turbine, an internal-combustion engine, etc., and power generation capacity is hundreds ˜500 kW class) has many examples installed in a hotel, a sport institution, office, a public facility, etc.

The present invention is also aimed at a small heat/electric power supply system (home use).

A generator contains an alternative current generator or a direct current generator.

The case of an alternative current generator

Although an alternative current generator is generally used when operating heat engine such as a gas turbine or an internal-combustion engine, in the case of the electric power load of alternative-current, electric power supply is carried out directly, but in the case of direct-current load, direct-current conversion is carried out by the converter, and electric power supply is carried out.

The case of a direct current generator

Like a fuel cell, in a direct current generator, when supplying electric power to an alternative-current load, it changes into alternative current electric power, and electric power is supplied by an inverter.

In addition, in a direct current generator, a converter is unnecessary and electric power generated by a generator is directly stored in a power storage unit as alternative current electric power, when storing electric power in a power storage unit (a storage battery).

On the other hand, when storing electric power generated by alternative current generator in a power storage unit, after carrying out direct-current conversion by the converter, it will be stored in a power storage unit.

And by passing to an inverter, electric power stored in a power storage unit is changed into alternative-current electric power, and is supplied to the electric power load.

(5) Power storage unit

A power storage unit includes the equipment which stores hydrogen and oxygen manufactured by electrolyzing water in the time zone when power consumption of the electric power load is more than specific value C1, is included.

Or an equipment with at least one sort or two sorts or more chosen among a lithium secondary battery, a nickel hydroid battery, and a capacitor is included.

The capacitor is convenient to correspond to the rapid increase in electric load.

Using together with a lithium secondary battery etc. is desirable.

As for capacity of a power storage unit, it is 20 kWh or less, 15 kWh or less, 10 kWh or less, 5 kWh or less, or 2 kWh or less, for example.

In addition, generally, a power storage unit needs a converter which changes commercial electric power (alternative current electric power) into direct current electric power, and needs an inverter which changes direct current electric power stored in the storage battery into an alternative current electric power.

And when storing alternative-current electric power generated by a alternative current generator, after changing into direct current electric power by the converter, direct current electric power is stored in a power storage unit.

The converter is unnecessary when electric power conserved is alternative current electric power (in the case of direct current electric power generated by a direct current generator).

Moreover, in the case of the electric power load of direct current, it becomes unnecessary (the inverter installed in the slipstream side of a power storage unit), and the system is simplified.

(6) A peak time zone

Generally a peak time zone means a peak time zone of electric power consumption of a heat/electric power supply system, and power consumption says the time zone t1˜t2 is beyond a specific-output C1.

The system which judges strictly that power consumption is more than a specific output C1 every moment t can be considered.

Or the system which sets beforehand the time zone when power consumption of the electric power load is more than a specific output C1 as t1˜t2 is also considered from the data of a fixed period.

Power consumption is changed according to the season of spring, summer, fall and winter (seasonal variation), and is changed in daytime and night in one whole day (day-and-night change).

A peak time zone means a peak time zone of day-and-night change in the present invention.

Although the time zone says the time range of a certain range, when the time range is very short, it says a moment and a peak time zone is synonymous with a peak moment.

In addition, generally a peak time zone of power consumption of a heat/electric power supply system and a peak time zone of commercial electric power tend to be in agreement.

(7) The time zone with the little electric power load (power consumption) and the time zone when the electric power load (power consumption) falls means the time zone t3˜t4 (for example, evening charge time zone) when power consumption of the electric power load is less than the specific output C2.

The system judged every moment t strictly can be considered.

Or power consumption of the electric power load sets up t3˜t4 beforehand from the data of a fixed period as the time zone which is more than a specific output C2, and it is also possible to store commercial electric power in a power storage unit in the time zone t3˜t4.

(8) A converter, an inverter

A converter changes alternative current electric power into direct current electric power.

Moreover, an inverter changes direct current electric power into alternative current electric power.

(9) The time zone t1˜t2, the time zones t3˜t4

As the time zone t1˜t2, 9:00 a.m.˜6:00 p.m., 12:00 a.m.˜4:00 p.m., or 1:00 p.m.˜3:00 p.m. are illustrated, for example.

As the time zone t3˜t4, 0:00 a.m.˜7:00 a.m., 2:00 a.m.˜6:00 a.m., or 3:00 a.m.˜6:00 a.m. are illustrated, for example.

### BRIEF DESCRIPTION OF THE DRAWINGS

FIG. 1 is a block diagram of the 1st embodiment.

FIG. 2 is a block diagram of the 2nd embodiment.

FIG. 3 is a block diagram of the 3rd embodiment.

FIG. 4 is a block diagram of the 4th embodiment.

### DETAILED DESCRIPTION OF THE DRAWINGS

100 Heat/electric supply system
1 Fuel
2 Commercial electric power
3 Generator
4 waste heat recovery unit
5 Thermal load
6 Converter
7 Power storage unit
8 Inverter
9 The electric power load
11, 12, and 13 Switch

### BESTMODE OF EMDODYING THE INVENTION

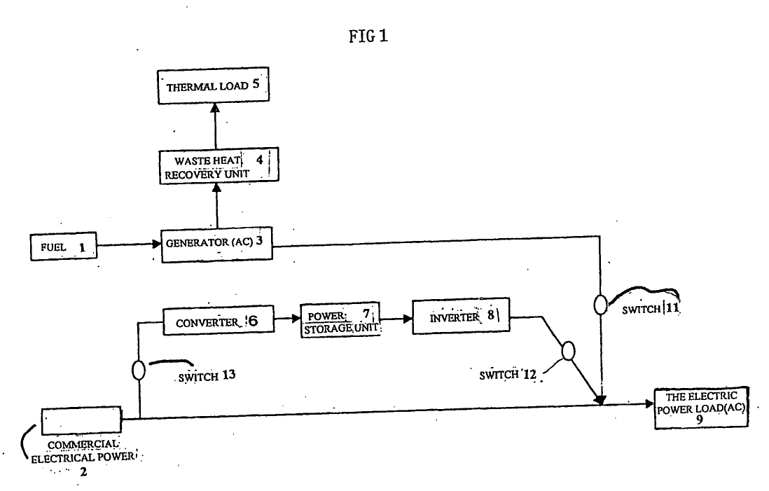

First, the case (refer to FIG. 1) of the electric power load of alternative-current and the generator of alternative-current is explained as an embodiment.

FIG. 1 is a block diagram of the 1st embodiment of the present invention (when the generator 3 is alternative-current and the electric power load 9 is alternative-current).

This heat/electric power supply system 100 of FIG. 1 contains the generator 3, the power storage unit 7 of alternative-current, and the waste heat recovery unit 4.

Electric power (in the case of alternative-current electric power, the voltage and frequency are substantially the same as those of commercial electric power 2, for example, they are 100V and 60 Hz.) generated by the generator 3 is supplied to the electric power load 9.

Fuel 1 is supplied to the generator 3.

Waste heat from the generator 3 is collected by the waste heat recovery unit 4, and, collected heat is supplied to the heat load 5 (as heat sources, such as air conditioning, heating, and hot-water supply).

Fuel 1 is supplied to the generator 3 and alternative-current electric power generated is supplied to the electric power load 9 of alternative-current by making the switch 11 opened.

On the other hand, waste heat generated in the generator 3 is collected by the waste heat recovery unit 4, and heat supply is carried out at the heat load 5.

While commercial electric power 2 is supplied to the electric power load 9 of alternative-current directly, in the time zone when the electric power load (power consumption) is little, it is sent to a converter 6 by making the switch 13 opened, is changed into direct current electric power, and is stored in the power storage unit 7.

Electric power stored in the power storage unit 7 is changed into alternative-current by the inverter 8 in a peak time zone, and is supplied to the electric power load 9 by making the switch 12 opened with commercial electric power 2 and electric power generated by the generator 3.

The switch 11 and the switch 12 are opened and closed and amount of distribution of three lines, commercial electric power 2, electric power by the generator 3, and electric power stored in the power storage unit 7, are adjusted by the control means (not shown).

In this case, electric power supplied to the electric power load is controlled by the control means, the synchronous injection equipment (not shown), the switch 11, and the switch 12 so that a phase is in agreement.

Moreover, the switch 13 is opened and closed and the power-storage start in the power storage unit 7 and a power-storage stop are performed by the control means (not shown).

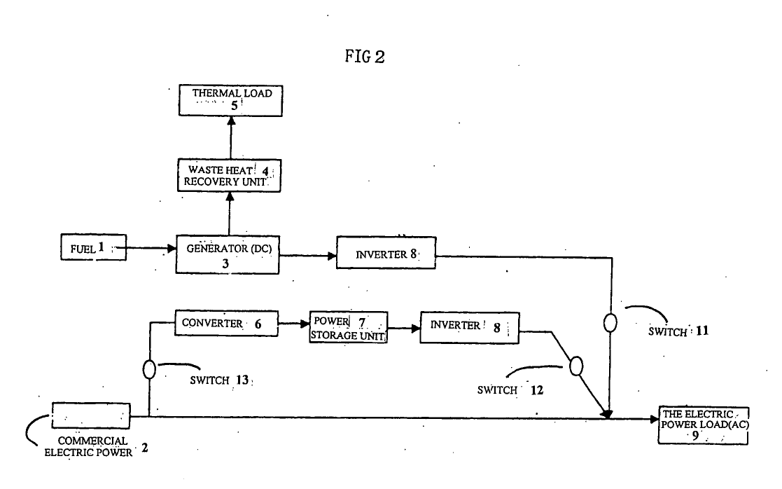

FIG. 2 is a block diagram of the other embodiments of the present invention (when a generator is direct current and the electric power load is alternative-current).

Although this system 100 of FIG. 2 is almost the same as the heat/electric power supply system of FIG. 1, it differs in FIG. 2 from in FIG. 1 that an inverter 8 is installed after the generator 3.

In this embodiment, the generator 3 of direct current, such as a fuel cell, is formed instead of the generator 3 of alternative-current of a 1st embodiment.

In the generator 3 of direct current, since direct-current electric power is obtained, when being stored in the power storage unit 7, the converter 6 is unnecessary.

Moreover, electric power from the direct current generator 3 is changed into direct current by the inverter 8.

Electric power from the power storage unit 7 is changed into alternative current electric power by an inverter 8.

Alternative-current electric power which passed through the inverter 8 from the direct current generator 3, and alternative-current electric power which passed through the inverter 8 from the power storage unit 7 are made to join together to be supplied to the electric power load 9, or are individually supplied to the electric power load 9.

Other compositions are similar with the previous embodiment, and give the same sign to the same apparatus.

In addition, we will explain a fuel cell below.

Fuel is reformed to hydrogen by a catalyst in a reforming equipment (not shown), in a fuel cell, this hydrogen and oxygen in air react to water, and direct current electric power occurs in that case.

This direct current electric power is stored in the direct power storage unit 7 like the previous embodiment, and direct current electric power from the power storage unit 7 is changed into alternative current electric power by the inverter 8, and is supplied to the electric power load.

Other compositions are similar with the 1st embodiment, and give the same sign to the same apparatus.

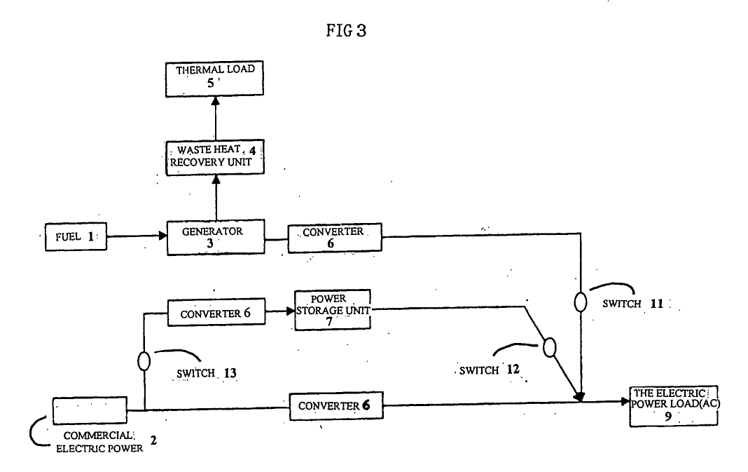

FIG. 3 is the 3rd embodiment (the generator 3 is of alternative-current and it is a block diagram in case that the electric power load 2 is of direct current.) of the present invention.

Although this system 100 of FIG. 3 is almost the same as the heat/electric power supply system of FIG. 2, that the converter 6 is installed after the generator 3 in FIG. 3 differs from there being no inverter 8 installed in the slipstream side of the power storage unit 7 in FIG. 2

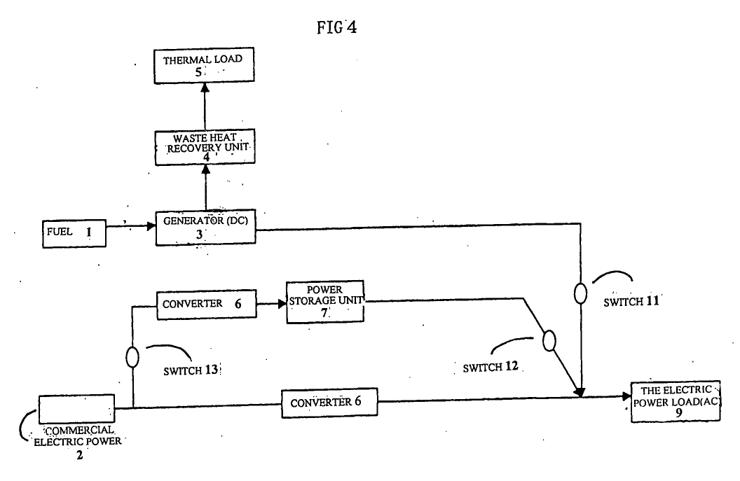

FIG. 4 is a block diagram of the 4th embodiment of the present invention (when the generator 3 is direct current and the electric power load 2 is direct current).

Although this system 100 of FIG. 4 is almost the same as the heat/electric power supply system 100 of FIG. 3, it differs in FIG. 4 that there is no converter 6 currently installed after the generator 3 in FIG. 3.

The generator (for example, a fuel cell containing a reform equipment) of direct current is used for the generator 3.

Other compositions are similar with the 3rd embodiment, and give the same sign to the same apparatus.

Invention as defined in claim 1 (fundamental invention of the present invention) is; a heat/electric supply system having a storage power unit characterized in that electric power is supplied from a generator, a commercial power supply and a power storage unit in a time zone when power consumption by the power load is higher than a specified output C1.

Although a control means (not shown) judges a time zone when power consumption of the electric power load is beyond a specific output C1, a control means is illustrated below and explained.

Power consumption of the electric power load is measured by a wattmeter (installed before the electric power load), and when measured electric power is more than a specific output C1, electric power is supplied to the electric power load by commercial electric power, electric power (usually, high-efficient about 70% output of the maximum output) of a generator, and electric power stored in a power storage unit.

For example, a specific output C1 is set to ⅔*C0 (here, C0 is taken as the peak-power value of the heat/electric power supply system.).

Thus, by setting up, in the time zone when the electric power load is ⅔*C0˜C0, a heat/electric power supply system provides for example ⅔*C0 with commercial electric power stored in a power storage unit and electric power from a generator, and can provide the remainder by commercial electric power.

This heat/electric power supply system needs only commercial electric power not more than ⅓*C0 as backup electric power in a peak time zone.

Or it does not judge every moment t strictly as mentioned above, but the time zone when power consumption of the electric power load is beyond a specific output C1 (for example, ⅔*C0 (C0 is taken as the peak power of the heat/electric power supply system, here.)) is set as t1˜t2 beforehand from the data of a fixed period, and in the time zone t1˜t2 (for example, the time zone is from the morning to the evening in the first.

For example, the time zone is from 9:00 a.m. to 6:00 p.m. or from 0:00 p.m. to 4:00 p.m.),we can also supply electric power to the electric power load by commercial electric power, electric power from a generator and electric power stored in a power storage unit.

The invention as defined in claim 2 is; a heat/electric supply system having a storage power unit as defined in claim 1, wherein commercial electric power is stored in a power storage unit in a time zone when power consumption by the power load is not more than a specific output C2.

Although a control means (not shown on these specifications) judges a time zone when power consumption of the electric power load is not more than the specific output C2, we will illustrate it.

A claim 2 invention is a heat/electric power supply system as defined in claim 1 characterized in that power consumption of the electric power load is measured with a wattmeter (installed before the electric power load 9), and when measured electric power is less than the specific output C2, commercial electric power is stored in a power storage unit.

Or it does not judge every moment t strictly, but is set as a time zone t3˜t4 (for example, night time zone, concretely, it will be from 0:00 p.m. to 6:00 p.m.) when power consumption of the electric power load is not more than the specific output C2 beforehand from the data of a fixed period, and, it will be also possible to store commercial electric power in a power storage unit by commercial electric power in the time zone t3˜t4 (for example, the night time zone, concretely from 0:00 p.m. to 6:00 p.m.).

In addition, in the present invention, even if power consumption of the electric power load is less than the specific output C2, power consumption of the electric power load exists and can be supplied by electric power generated by the generator of the present invention or commercial electric power.

The invention as defined in claim 3 is; a heat/electric supply system having a storage power unit as defined in claim 1˜2, wherein commercial electric power is stored in a power storage unit and is supplied to the power load in a time zone when power consumption by the power load is not more than a specific output C2.

Although a control means (not shown on these specifications) judges a time zone when power consumption of the electric power load is not more than the specific output C2, we will illustrate it.

A claim 3 invention is a heat/electric power supply system as defined in claim 1˜2 characterized in that power consumption of the electric power load is measured with a wattmeter (installed before the electric power load 9), and when measured electric power is less than the specific output C2, while electric power is supplied by commercial electric power, commercial electric power is conserved in a power storage unit.

For example, the specific output C2 is set to ⅓*C0 (C0 is taken as the peak output here.).

By setting up in this way in a heat/electric power supply system, if the electric power load will consume commercial electric power ⅓*C0 in the time zone not more than ⅓*C0, the whole quantity of the electric power load will be provided by commercial electric power, and remaining commercial electric power (⅓*C0—the electric power load) will be stored in a power storage unit.

According to this heat/electric power supply system, consumption of commercial electric power of ⅓*C0 is guaranteed also in the time zone with little power consumption.

Or it does not judge every moment t strictly, but t3˜t4 are set up beforehand from the data of a fixed period as the time zone when power consumption of the electric power load is less than the specific output C2, and commercial electric power may be stored in a power storage unit in the time zone t3˜t4.

In addition, generally C0≧C1≧C2, and we will explain this heat/electric power supply system in case that power consumption of the electric power load is the specific value C3 (C0≧C1≧C3≧C2) hereafter.

For example, if power consumption of the electric power load can be supplied to the electric power load only by commercial electric power, it is possible as an example to supply commercial electric power to the electric power load.

Or it is also possible as an example to supply both commercial electric power and electric power generated in a generator to the electric power load.

The invention As defined in claim 4 is; a heat/electric supply system having a storage power unit as defined in claim 1˜3, wherein commercial electric power is stored in a power storage unit or is supplied to the power load in a time zone when power consumption by the power load is not more than a specific output C2.

Since commercial electric power does not need to be stored in a power storage unit any longer when required electric power already has being stored in a power storage unit, commercial electric power is supplied to load electric power.

Moreover, since commercial electric power cannot be supplied when there is no electric power load, commercial electric power is only stored in a power storage unit.

The invention as defined in claim 5 is; a heat/electric supply system having a storage power unit as defined in claim 1˜4, wherein a component of heat/electric supply system is a gas turbine, an engine, or a fuel cell.

A fuel cell is a small high polymer electrolyte type fuel cell (2 kW or less of outputs).

The invention as defined in claim 6 is; a heat/electric supply system having a storage power unit as defined in claim 1˜5, wherein a generator is an alternative current generator or a direct current generator.

The invention as defined in claim 7 is; a heat/electric supply system having a storage power unit as defined in claim 1˜6, wherein hydrogen and oxygen are manufactured by electrolyzing water and stored in a time zone when power consumption by the power load is not more than a specific output C1.

It is possible to store electric power by electrolyzing water, manufacturing and storing hydrogen and oxygen, and using excessive commercial electric power.

When a generator is a fuel cell especially, hydrogen and oxygen which were stored may be used for power generation, by mixing hydrogen in hydrogen rich gas which was produced by reforming of fuel and by mixing oxygen in the air.

Or it is also possible to install another hydrogen oxygen fuel cell system.

The invention as defined in claim 8 is; a heat/electric supply system having a storage power unit as defined in claim 1˜7, wherein a power storage unit comprises one sort or two sorts or more chosen among a lithium secondary battery, a nickel hydride battery, and a capacitor.

The capacitor is suitable to correspond to the rapid increase in electric load.

Using together with a lithium secondary battery etc. is desirable.

The invention as defined in claim 9 is; a heat/electric supply system having a storage power unit as defined in claim 1˜8, wherein the heat collected from the heat recovery unit is supplied to one sort or two sorts or more chosen among an absorption type freezer and a warm water boiler.

Claim 9 Invention is a heat/electric power supply system as defined in claim 1˜2 characterized in that heat collected by the above-mentioned waste heat recovery unit is supplied to the above-mentioned heat load, and cold water obtained by an absorption type freezer and warm water obtained by a warm water boiler are used for air-conditioning.

If the present invention is followed, collected waste heat will be supplied to an absorption type freezer, and cold water obtained by an absorption type freezer will be used for air conditioning during the period when air conditioning is needed.

Moreover, during the period when heating is needed, collected waste heat is supplied to a warm water boiler, and warm water obtained by a warm water boiler is used for heating.

By this, the electric power load used for air-conditioning apparatus etc., such as a pump for water supply of coldness-and-warmth water, and a ventilation fan, becomes few.

In addition, heat recovery of exhaust gas of an absorption type freezer or a warm water boiler can be further carried out with a hot-water supply machine etc.

The invention as defined in claim 10 is; a heat/electric supply system having a storage power unit as defined in claim 1˜9, wherein a time zone contains a time zone at night or a time zone when power consumption by the power load is not more than specific value C2 is only a time zone at night.

This claim defines more concretely the time zone when power consumption of the electric power load is not more than a specific value C2.

The invention as defined in claim 11 is; a heat/electric supply system having a storage power unit as defined in claim 1˜10, wherein a time zone when power consumption by the power load is higher than a specified output C1 is read as a time zone of peak power consumption of the electric power load.

Although a control means (not shown) judges a time zone when power consumption of the electric power load is beyond a specific output C1, the compositions to judge whether power consumption of the electric power load is more than a specific output C1 causes complication of a control means.

Therefore, instead of judging the time zone when power consumption of the electric power load is more than a specific output C1, electric power from a generator, commercial electric power, and electric power stored in a power storage unit are used together and supplied in a peak time zone (the time zone when t1˜t2) of power consumption of the electric power load, since it is possible to expect whether power consumption of the electric power load is more than a specific output C1.

In the present invention, in a peak time zone (the time zone when t1˜t2) when power consumption of the electric power load, it is not always necessary to use together electric power from a generator, commercial electric power and electric power stored in a power storage unit. Then, We think in a wide sense that electric power stored in a power storage unit, commercial electric power, and electric power from a generator may be used together to be supplied in a peak time zone (the time zone when t1˜t2) of power consumption of the electric power load.

Thus, even if we think in a wide sense, it is because the characteristic effect of the present invention which can miniaturize the whole heat/electric power supply system and can realize the cost cut of the system can be attained, by using together three electric powers, that is, electric power from a generator, commercial electric power, electric power in a power storage unit in a peak time zone. The invention as defined in claim 12 is; a heat/electric supply system having a storage power unit as defined in claim 1˜11, wherein a time zone when power consumption of the electric power load falls is read as a time zone when power consumption by the power load is not more than a specific output C2.

Although a control means (not shown) judges that power consumption of the electric power load is less than the specific output C2, judging whether power consumption of the electric power load is less than C2 by a control means causes complication of a control means.

Therefore, since the time zone when power consumption of the electric power load is less than the specific output C2 can be expected, in the time zone (the time zone when t3˜t4) when power consumption falls, commercial electric power is stored in a power storage unit.

It is not always necessary to store commercial electric power in a power storage unit, and then we think in a wide sense that commercial electric power may be stored in a power storage unit in the time zone (the time zone when t3˜t4) when power consumption falls.

Thus, even if we thinks in a wide sense, since commercial electric power stored in a power storage unit can be used for the peak hour by storing commercial electric power in a power storage unit in the time zone when power consumption falls, since the backup electric energy of the peak hour decreases and leveling of the load for one whole day of commercial electric power is carried out still more sharply, the characteristic effect of the present invention which has a merit also for an electric industry company that realization of a smaller heat/electric power supply system can be attained.

The invention as defined in claim 13 is; a heat/electric supply system having a storage power unit as defined in claim 1˜12, wherein a time zone when power consumption by the power load is not more than a specific output C2 is read as the night time.

In invention as defined in claim 12, the time zone when power consumption falls is limited with the time zone at night.

### EFFECT OF THE INVENTION

By considering as the composition of the present invention, the objection of the present invention already described was fully able to be attained.

That is, by using three electric power together, that is, electric power from a generator, commercial electric power, electric power stored in a power storage unit and supplying electric power in a peak time zone when commercial electric power is more than a specific output C1, the whole heat/electric power supply system could be miniaturized and the cost cut of the system was attained.

It became possible to consider as a small home system and to be able to aim at large spread by this.

Moreover, it is the composition of the present invention that electric power is supplied by commercial electric power/or electric power is supplied by commercial electric power and simultaneously electric power is stored in a power storage unit, in the time zone when power consumption of the electric power load is not more than the specific output C2 (for example, evening charge time zone of commercial electric power).

Since leveling of the load for one whole day of commercial electric power would be carried out using the composition of this present invention, i.e., by using positively commercial electric power in the evening charge time zone, realization of a smaller heat/electric power supply system which has a merit also for an electric industry company was enabled.

Since commercial electric power stored in a power storage unit was used for the peak hour by storing commercial electric power in a power storage unit in the time zone especially at night, it led to amount of backup electric energy for a peak hour decreasing, and it became possible to carry out leveling of the commercial electric power load for one whole day still more sharply.

This enabled realization of a smaller heat/electric power supply system which has a merit also for an electric industry company.

By the above, a possibility that the heat/electric power supply system for small (for example, home use) would spread may be especially increased by considering as the small heat/electric power supply system good of installation performance and cheap of equipment cost.

Moreover, it was able to consider as the system which is easy for an electric industry company to accept by using positively commercial electric power in the evening charge time zone or by equalizing the commercial electric power load more rather than a self-conclusion type heat/electric power supply system or a commercial electric power backup-type heat/electric power supply system.

Furthermore, large spread for small can be expected by considering as the heat/electric power supply system having a power storage unit of the present invention.

By storing commercial dump power at night in a power storage unit of the heat/electric power supply system installed dispersedly, and supplying conserved commercial electric power for the commercial electric-power peak hour, the commercial electric power load of the whole state will be equalized, and it became possible to demonstrate a merit that the installation time of large-sized plant is delayable.

Since commercial electric power can be stored in a power storage unit of the heat/electric power supply system of which distributed installation spreads, so to speak, an effect equal to building the reservoir for the pumped hydro power generation is demonstrated.

In addition, a possibility of demonstrating the effect that the present invention can contribute to power consumption cut in a peak time zone of commercial electric power of the whole state increased also by storing electric power of the generator of a heat/electric power supply system in a power storage unit.

Moreover, when this high heat/electric power supply system of energy efficiency spread broadly, the possibility of execution of a national energy-saving policy increased.

By the above, a possibility that the heat/electric power supply system would spread for small one(for example, home use)especially increased by considering as the heat/electric power supply system which is small, good of installation performance, and cheap of equipment cost

Moreover, it was able to consider as the system which is easy for an electric industry company to accept by using positively commercial electric power in the evening charge time zone, and by equalizing commercial electric power load more rather than a self-conclusion type heat/electric power supply system or a commercial electric power backup-type heat/electric power supply system.

Furthermore, large spread for small one can be expected by considering as the heat/electric power supply system having a power storage unit of the present invention.

By storing commercial dump power at night in a power storage unit of the heat/electric power supply system installed dispersedly, and supplying conserved commercial electric power for a commercial electric-power peak hour, the commercial electric power load of the whole state will be equalized, and it became possible to demonstrate a merit that the installation time of large-sized plant is delayable.

Since commercial electric power can be stored in a power storage unit of the heat/electric power supply system of which distributed installation spreads, so to speak, an effect equal to building the reservoir for the pumped hydro power generation is demonstrated.

In addition, a possibility of demonstrating the effect that the present invention can contribute to power consumption cut in a peak time zone of commercial electric power of the whole state increased also by storing electric power of the generator of a heat/electric power supply system in a power storage unit.

Moreover, when this high heat/electric power supply system of energy efficiency spread broadly, the possibility of execution of a national energy-saving policy increased.

1. A heat/electric supply system comprising means for supplying electric power during power demand of peak levels in a time period of a transition between daylight and nighttime, said means comprising an electric generator, a commercial power supply and an electric power storage unit.

2. A heat/electric supply system according to claim 1, further comprising means for storing commercial electric power in the power storage unit in a time period when power demand is not more than a predetermined level below said peak levels.

3. A heat/electric supply system according to claim 1, further comprising means for supplying power from the power storage unit in a time period when demand is not more than a predetermined level.

4. A heat/electric supply system according to claim 1, further comprising means for storing power in or supplying power from the power storage unit in a time period when demand is not more than a predetermined level.

5. A heat/electric supply system according to claim 1, comprising a gas turbine, an engine, or a fuel cell.

6. A heat/electric supply system having a storage power unit as defined in claim 1, wherein the generator is an alternate current generator or a direct current generator.

7. A heat/electric supply system according to claim 1, wherein the power storage unit comprises means for manufacturing hydrogen and oxygen by electrolyzing water and storing said hydrogen and oxygen in a time period when power demand is below said peak levels.

8. A heat/electric supply system according to claim 1, comprising at least one of a lithium secondary battery, a nickel hydride battery, and a capacitor.

9. A heat/electric supply system according to claim 1, comprising a heat recovery unit, said heat recovery unit comprising at least one of a freezer operating by absorption and a warm water boiler, and means for supplying heat from the heat recovery unit to at least one of the freezer and the warm water boiler.

10. A heat/electric supply system according to claim 1, wherein said time period when power demand is not more than a predetermined level below said peak levels includes or consists only of nighttime.

11-12. (cancelled).

13. A heat/electric supply system according claim 10, wherein said time period when power demand is not more than a predetermined level below said peak levels consists only of nighttime.

14. Method for supplying heat/electricity from a system comprising a generator, a commercial power supply and an electric power storage unit, comprising storing electric power in the power storage unit during periods of reduced power demand and augmenting power supply by supplying power from the electric power storage unit together with power from the generator and power from the commercial power supply during power demand of peak levels in a time period of transition between daylight and nighttime.

15. Method according to claim 14, further comprising supplying power from the commercial supply to, and storing the supplied power in, the power storage unit when the power demand is not more that a predetermined level below the peak levels.
